(19) United States
(12) Patent Application Publication
(10) Pub. No.: US 2011/0200721 A1
(43) Pub. Date: Aug. 18, 2011

(54) PRODUCTION OF BEADLETS COMPRISING HYGROSCOPIC PLANT EXTRACTS

(75) Inventors: Elger Funda, Grenzach-Wyhlen (DE); Karin Leuthardt, Basel (CH)

(73) Assignee: DSM IP ASSETS B.V., Heerlen (NL)

(21) Appl. No.: 13/057,205

(22) PCT Filed: Jul. 31, 2009
(86) PCT No.: PCT/EP2009/059959

§ 371 Date: May 2, 2011

(30) Foreign Application Priority Data
Aug. 4, 2008 (EP) 08161734.2

(51) Int. Cl. A23L 1/00; A23L 1/28

(52) U.S. Cl. 426/289; 426/655

(57) ABSTRACT

The present invention relates a process of production of beadlets comprising hygroscopic plant extracts in a matrix comprising at least one starch and/or starch derivative, to such beadlets and to the use of such specific beadlets in food (for humans and animals) as well as in premixes.

The present invention relates to a process of production of beadlets comprising hygroscopic plant extracts in a matrix comprising at least one starch and/or starch derivative, to such beadlets and to the use of such specific beadlets.

Hygroscopic plant extract in the context of the present invention relates to plant extracts, which comprises amorphous sugar(s) or other hygroscopic compounds.

Plant extracts can be made by methods known in the arts including a polar extract such as an aqueous extract, an alcohol extract (e.g., ethanol, methanol, hexane, hydroalcohol,) or a non-polar extract (e.g., isooctane).

Preferred hygroscopic plant extracts in the context of the present invention are extracts from cruciferous plants.

Plant extracts of cruciferous plants such as rocket, broccoli, cabbage, watercress, radish cabbage, bok choy, collards, brussels sprouts, kohlrabi, kale, mustard greens, turnip greens, and cauliflower are known having a good effect on various aspects of health. These vegetables contain phytochemicals that help to strengthen the immune system and thereby help the body to build resistance against viruses and diseases. Cruciferous vegetables are rich in the antioxidant vitamins C, E, and beta-carotene, and are a good source of dietary fibre.

Cruciferous vegetables also contain glucoraphanin and other isothiocyanates, which are believed to stimulate the production of protective enzymes in the body. These powerful enzymes detoxify toxins and other problem-causing agents and flush them from the body.

The term “cruciferous plant extract” is defined as an extract made from a cruciferous plant. The extract can be obtained from any part of the plant, usually from the seeds or sprouts.

The extracts of these plants allow a wide range of uses. The extract can be incorporated in many forms of application. Food products and dietary supplements is one of these fields. It is possible to have the positive effects of the ingredients without the need of eating the whole plant or even without having the smell or taste of the plants.

Plant extracts are often hygroscopic. They tend to take up water from humid air and become sticky or even liquefy at ambient conditions. This makes these extracts very difficult to dry, process and handle.

A very typical form of formulation of substances used in consumer products (such as for example food products) are powders. Powders can be produced by spray drying or freeze drying processes. These formulations can contain a high content of one water soluble and/or water-dispersible hygroscopic substance as well as mixture of at least two water soluble and/or water-dispersible hygroscopic substances. But when using powders comprising hygroscopic substances, there are a few problems:
The powders are still hygroscopic.
Dry powders are usually dusty and therefore the handling can be difficult.

To solve the problem of hygroscopicity, additives like maltodextrins, silica or Ca-stearate are added to the extract. But in many cases, the hygroscopicity of the resulting powders is still too high for the use in applications like tabletting.

Another well known form of preparations are beadlets. Beadlets provide superior handling properties in that they are not dusty and possess good flowablity characteristics. Beadlets are solely known for fat-soluble substances.

Beadlets (comprising fat-soluble substances) and their methods of productions are known from the prior art. These beadlets comprise fat-soluble (lipophilic, hydrophobic) substances. Such beadlets and their process for production are for example known from US2006/0115534 and U.S. Pat. No. 4,670,247. These beadlets usually have good storage stability, but the concentration of the fat-soluble substances in such beadlets is low. Usually the content is between 5-15 weight-% (wt-%), based on the total weight of the beadlet.

Another disadvantage is that the production of such beadlets requires an emulsification or dispersion step to distribute the water-insoluble active in the aqueous matrix phase.

Therefore, the matrix material needs to have emulsifying properties or an additional emulsifier is required.

The goal of the present invention was to find a process for producing formulations comprising water-soluble or water-dispersible hygroscopic substances, which
allows producing non-hygroscopic formulations with a high amount of water-soluble or water-dispersible hygroscopic substances
produces storage stable formulations
is a simple process.

Surprisingly, it has been found that the use of the powder catch process allows producing such formulations, which are in the form of beadlets having the above mentioned advantages. The beadlets comprise a hygroscopic plant extract (or a mixture of various different plant extracts) and one starch and/or starch derivative (or a mixture of starches and/or starch derivatives) as a matrix material. Furthermore these beadlets are coated with a layer of the powder catch medium.

Therefore, the present invention relates to a process for preparing beadlets, which comprise at least one hygroscopic plant extract, comprising:
(a) forming an aqueous solution of
   (i) at least one hygroscopic plant extract and
   (ii) at least one starch and/or at least one starch derivative,
(b) converting the solution into a dry powder by spray drying into a collecting powder.

Such a process is known from the prior art. It can be found for example in U.S. Pat. No. 6,444,227 or WO04062382. These references are hereby incorporated by reference.

Preferred hygroscopic plant extracts are cruciferous plant extracts. Plant extracts of cruciferous plants are for example rocket, broccoli, cabbage, watercress, radish cabbage, bok choy, collards, brussels sprouts, kohlrabi, kale, mustard greens, turnip greens and cauliflower.

Therefore a preferred embodiment of the present invention relates to a process for preparing beadlets, which comprise at least one cruciferous plant extract.

A more preferred embodiment of the present invention relates to a process for preparing beadlets, which comprise at least one hygroscopic plant extract, which is a cruciferous plant extract chosen from the group consisting of rocket, broccoli, cabbage, watercress, radish cabbage, bok choy, collards, brussels sprouts, kohlrabi, kale, mustard greens, turnip greens and cauliflower, preferably broccoli.

The hygroscopic plant extracts (preferably cruciferous plant extracts) are formulated in a beadlet by a matrix material, which comprises at least one starch and/or starch derivative.

Starch having the chemical formula (C₆H₁₀O₅)ₙ is a polysaccharide carbohydrate consisting of a large number of glucose monosaccharide units joined together by glycosidic bonds.

All plant seeds and tubers contain starch. Starches are commonly extracted from plants, such as corn, sorghum, wheat, rice, tapioca, arrowroot, sago, potato, quinoa and amaranth.

Natural starches contain usually amylase and amylopectin molecules. The content of amylase in natural starches can vary from 0 wt-% (for example waxy corn starch and waxy rice starch) up to about 85 wt-% (High amylase corn starch). Normal starches contain about 25 wt-% of amylase. As a consequence thereof the content of amylopectin is between 15 and 100 wt-%.

It is also possible to use starch derivatives (modified starches) including hydrolysed starches. The starches can be modified in various manners. It can be done physically and chemically.

Pregelatinised starches are examples of physically modified starches.

Acidic modified, oxidized, cross-linked, starch esters, starch ethers and cationic starches are examples of chemically modified starches. Important examples of such modified starches are octenyl succinic anhydride starches (OSA starches).

Dextrins like maltodextrin or yellow dextrin are examples of starch derivatives obtained by partial hydrolysis.

In a preferred process according to the present invention the starches or starch derivatives are chosen from the group consisting of amylopectin, OSA starches, maltodextrin and pregelatinised starches.

The matrix of the beadlets of the present invention can also comprise additional compounds, such as sugar. Sugar refers to any monosaccharide or disaccharide (preferred is sucrose).

A preferred process according to the present invention is a powder catch process. Such a process is known from the prior art (for example from WO04062382). As a result of such a powder catch process the beadlets are covered by a layer of the powder.

Therefore, the beadlets produced according to this process are preferably covered by a layer of the powder catch medium. This layer (coating) is in the form of a powder coating.

The powder catch medium is a compound (or a mixture of compounds), which is able to absorb moisture and to form a powder coating. Suitable powder catch media are i.e. starches, silicate or phosphate compounds. Preferred powder catch media are starches (such as i.e. corn starch), calcium silicate, calcium aluminium silicate and tri-calcium phosphate. Most preferred are starches, especially corn starch.

Beadlets are a well known form of formulation for fat-soluble substances. An important advantage of the generally spherical beadlets is that they are not dusty and that they posses excellent free flowing characteristics, which are very desirable for manufacturing and formulating operations.

Usually the size of a beadlet is from 50 μm to 1,000 μm (preferably from 250 μm to 850 μm). The sizes can be smaller or larger. The size of a beadlet can be determined according to well known methods, such as (scanning) electron microscopy.

A suitable method to produce beadlets as disclosed and described above is for example described in WO 2004/062382. This reference is hereby incorporated.

The process according to the present invention surprisingly allows producing beadlets with a high amount of hygroscopic plant extract (preferably cruciferous plant extract) with good overall properties.

The process as described in the present patent application can be used not only to produce beadlets with a high amount of hygroscopic plant extract (preferably cruciferous plant extract), but also with a low amount thereof. The amount can be as low as 1 wt-%, based on the total weight of the beadlets, Usually the content of the hygroscopic plant extract (preferably cruciferous plant extract) in the beadlets is at least 5 wt-%, preferably at least 10 wt-%, based on the total weight of the beadlets.

A preferred process according to present invention relates to a process according as described above wherein the beadlets comprise at least 30 wt-%, based on the total weight of the beadlets, of at least one hygroscopic plant extract (preferably cruciferous plant extract).

A further preferred process according to present invention relates to a process according as described above wherein the beadlets comprise up to 85 wt-%, based on the total weight of the beadlets, of at least one hygroscopic plant extract (preferably cruciferous plant extract).

A preferred process according to present invention relates to a process wherein the beadlets comprise up to 80 wt-%, based on the total weight of the beadlets, of at least one hygroscopic plant extract (preferably cruciferous plant extract).

A preferred process according to present invention relates to a process wherein the beadlets comprise at least 5 wt-%, based on the total weight of the beadlets, more preferred at least 20 wt-%, of at least one starch and/or at least one starch derivative (matrix material) and of the powder coating layer.

A preferred process according to present invention relates to a process wherein the beadlets comprise

at least 5 wt-%, based on the total weight of the beadlets, of powder coating layer.

A more preferred process according to present invention relates to a process wherein the beadlets comprise

(i) 5 wt-%-85 wt-%, preferably 30 wt-%-80 wt-%, more preferably 40 wt-%-70 wt-%, based on the total weight of the beadlets, of at least one hygroscopic plant extract (preferably cruciferous plant extract), and

(ii) 5 wt-%-90 wt-%, preferably 25 wt-%-50 wt-%, based on the total weight of the beadlets, of at least one starch and/or at least one starch derivative, and

(iii) 5 wt-%-50 wt-%, preferably 5 wt-%-20 wt-%, based on the total weight of the beadlets, of powder coating.

An especially embodiment of the present invention relates to a process, wherein the starch component (ii), always comprise maltodextrin and at least one further starch and/or at least one further starch derivate.

The matrix of the beadlets of the present invention as described above can also comprise additional compounds. Such compounds can be any kind of auxiliaries used in the field of beadlet producing and/or food and feed technology. A preferred compound is sugar (sucrose).

A further embodiment of the present invention relates to a process for preparing beadlets, which comprise at least one hygroscopic plant extract, comprising:
(a) forming an aqueous solution of
   (i) at least one hygroscopic plant extract and
   (ii) at least one protein,
(b) converting the solution into a dry powder by spray drying into a collecting powder.

The hygroscopic plant extracts are as defined above.

Proteins are large organic compounds made of amino acids arranged in a linear chain and joined together by peptide bonds between the carboxyl and amino groups of adjacent amino acid residues.

All living tissues (animals, human and plants) contain proteins.

Proteins are available as isolates, concentrates, meals and hydrolysates. Protein isolates contain more than 90% protein. Protein concentrates contain 60-90% protein. Protein meals contain less than 60% protein. In protein hydrolysates, a part of the peptide bonds is broken either chemically, e.g. by acid or enzymatically. Thereby the molecular weight and the degree of polymerisation of the protein is reduced. The amount of hydrolysis is described by the degree of hydrolysis (DH). The DH is the percentage of broken peptide bonds compared to all peptide bonds. Therefore a DH of 0% describes a native protein while a DH of 100% describes a completely hydrolysed protein.

The protein content in plants is very small. In contrast to plants, animal and human bodies are composed largely of proteins.

Sources of plant proteins are for example peas, beans (such as soya beans, castor beans, etc), lupins, cotton, potatoes, sweet potatoes, manioc, rapeseed, sunflowers, sesame, linseed, safflower, lentils, nuts, wheat, rice, maize, barley, rye, oats and sorghum.

Sources of animal proteins are for example blood, bones, skin and milk and eggs.

Sources of microbial proteins are for example bacteria or yeasts.

For the invention of the present patent application the following proteins are preferred: gelatines (especially fish and poultry), hydrolysed gelatines and milk proteins (casein, whey proteins).

Besides native protein isolates, concentrates or meals, proteins can be modified either mechanically, thermally, chemically or enzymatically.

Partial denaturation of the protein e.g. by heat treat may be used to improve the gel-forming properties of the protein. The protein may also be crosslinked e.g. enzymatically by transglutaminase.

To improve solubility or viscosity, the protein may be partially hydrolysed either chemically or enzymatically by proteases.

In the context, the term “proteins” includes native proteins as isolates, concentrates or meals as well as modified, denatured or crosslinked proteins or hydrolysates.

Therefore the present invention also related to a process as described above, wherein the protein is a protein isolate, concentrate or meal.

The present invention also relates to a process as described above, wherein the protein is a protein hydrolysate.

The present invention also relates to a process as described above, wherein the protein is a heat-treated.

The present invention also relates to a process as described above, wherein the protein is crosslinked.

The matrix of the beadlets of the present invention can also comprise additional compounds, such as maltodextrin and/or sugar (sucrose). A preferred combination of matrix materials is the combination of sucrose and protein.

A more preferred process according to present invention relates to a process wherein the beadlets comprise

(i) 5 wt-%-85 wt-%, preferably 40 wt-%-70 wt-%, based on the total weight of the beadlets, of at least one hygroscopic plant extract (preferably cruciferous plant extract), and

(ii) 5 wt-%-90 wt-%, preferably 25 wt-%-50 wt-%, based on the total weight of the beadlets, of at least one protein, and

(iii) 5 wt-%-50 wt-%, preferably 5 wt-%-20 wt-%, based on the total weight of the beadlets, of powder coating.

In preferred embodiments of the present invention the hygroscopic plant extract is a cruciferous plant extract.

In more preferred embodiments of the present invention the hygroscopic plant extract is a cruciferous plant extract chosen from the group consisting of rocket, broccoli, cabbage, watercress, radish cabbage, bok choy, collards, brussels sprouts, kohlrabi, kale, mustard greens, turnip greens and cauliflower, more preferably broccoli.

As mentioned above the matrix of the beadlets of the present invention can also comprise additional compounds. A preferred compound is maltodextrin and/or sugar (sucrose).

A further embodiment of the present invention relates to a process for preparing beadlets, which comprise at least one hygroscopic plant extract, comprising:
(a) forming an aqueous solution of
   (i) at least one hygroscopic plant extract and
   (ii) at least one gum compound,
(b) converting the solution into a dry powder by spray drying into a collecting powder.

The hygroscopic plant extracts are as defined above.

The term gum in the context of the present invention is defined as polysaccharides. Polysaccharides made up of only one type of neutral monosaccharide structural unit and with only one type of glycosidic linkage—as in cellulose or amylose—are denoted as perfectly linear polysaccharides. In branched polysaccharides the frequency of branching sites and the length of the side chains can vary greatly. Molecules with a long “backbone” chain and many short side chains are called linearly branched polysaccharides.

Polysaccharides are water soluble or swell in water, giving colloidal, highly viscous solutions or dispersions with plastic or pseudoplastic flow properties. Functional properties such as thickening, water holding and binding, stabilization of suspensions and emulsions, and gelling, are based on this behavior. Therefore, polysaccharides are often referred to as gelling or thickening agents, stabilizers, water binders, or fillers.

Examples of gums are agar, alginate, arabinoxylan, carrageenan, chitosan, gellan, curdlan, β-glucan, guar gum, gum arabic (=gum acacia), locust bean gum, pectin, and xanthan gum.

The matrix of the beadlets of the present invention can also comprise additional compounds, such as maltodextrin and/or sugar (sucrose). A preferred combination of matrix materials is the combination of maltodextrin and gums.

A more preferred process according to present invention relates to a process wherein the beadlets comprise

(i) 5 wt-%-85 wt-%, preferably 30 wt-%-80 wt-%, more preferably 40 wt-70 wt-%, based on the total weight of the beadlets, of at least one hygroscopic plant extract (preferably cruciferous plant extract), and

(ii) 5 wt-%-90 wt-%, preferably 25 wt-%-50 wt-%, based on the total weight of the beadlets, of at least one gum compound, and

(iii) 5 wt-%-50 wt-%, preferably 5 wt-%-20 wt-%, based on the total weight of the beadlets, of powder coating.

In preferred embodiments of the present invention the hygroscopic plant extract is a cruciferous plant extract.

In more preferred embodiments of the present invention the hygroscopic plant extract is a cruciferous plant extract chosen from the group consisting of rocket, broccoli, cabbage, watercress, radish cabbage, bok choy, collards, brussels sprouts, kohlrabi, kale, mustard greens, turnip greens and cauliflower, more preferably broccoli.

As mentioned above the matrix of the beadlets of the present invention can also comprise additional compounds. When a gum compound is used in the matrix, the a preferred combination of matrix materials is the combination of maltodextrin and gums. Maltodextrin and gum arabic is an especially preferred embodiment of the present invention. The ratio of maltodextrin:gum arabic can be 5:1 to 1:5.

A further embodiment of the present invention relates to a process for preparing beadlets, which comprise at least one hygroscopic plant extract, comprising:
(a) forming an aqueous solution of
   (i) at least one hygroscopic plant extract and
   (ii) at least one synthetic and/or semi-synthetic polymer,

(b) converting the solution into a dry powder by spray drying into a collecting powder.

The hygroscopic plant extracts are as defined above.

Synthetic polymers in the context of the present invention are defined as polymers chemically manufactured from separate materials. Polymers are macromolecules, composed of repeating structural units (monomers), which are connected by covalent chemical bonds. Synthetic polymers can be obtained from one or more monomers by polymerisation reactions like poly-addition, poly-condensation or anionic or cationic polymerisation. Most synthetic polymers are used for non-food applications like plastics or elastomers, but some are also approved for use in food, feed or pharmaceutical applications.

Preferred synthetic polymers are polyethylene glycols (PEG) and polyvinyl pyrrolidone.

Semi-synthetic polymers in the context of the present invention are obtained from polymers of natural origin by chemical modification. Preferred semi-synthetic polymers are based on cellulose or lignin as macromolecular backbone.

Semi-synthetic polymers comprise ethers and esters of cellulose or lignin, like carboxymethyl cellulose, cellulose acetate phthalate, hydroxypropyl-methyl cellulose, ethyl cellulose, methyl cellulose or lignosulfonates

The matrix of the beadlets of the present invention can also comprise additional compounds, such as maltodextrin and/or sugar (sucrose). A preferred combination of matrix materials is the combination of maltodextrin and a synthetic and/or semi-synthetic polymer

A more preferred process according to present invention relates to a process wherein the beadlets comprise

(i) 5 wt-%-85 wt-%, preferably 30 wt-%-80 wt-%, more preferably 40 wt-70 wt-%, based on the total weight of the beadlets, of at least one hygroscopic plant extract (preferably cruciferous plant extract), and

(ii) 5 wt-%-90 wt-%, preferably 25 wt-%-50 wt-%, based on the total weight of the beadlets, of at least one synthetic and/or semi-synthetic polymer, and

(iii) 5 wt-%-50 wt-%, preferably 5 wt-%-20 wt-%, based on the total weight of the beadlets, of powder coating.

In preferred embodiments of the present invention the hygroscopic plant extract is a cruciferous plant extract.

In more preferred embodiments of the present invention the hygroscopic plant extract is a cruciferous plant extract chosen from the group consisting of rocket, broccoli, cabbage, watercress, radish cabbage, bok choy, collards, brussels sprouts, kohlrabi, kale, mustard greens, turnip greens and cauliflower, more preferably broccoli.

Beadlets comprising a high amount (at least 30 wt-%) of hygroscopic plant extract (preferably cruciferous plant extract) in a matrix comprising at least one starch and/or at least one starch derivative are not known from the prior art.

A further embodiment of the present invention relates to beadlets (B1) comprising

(i) at least 30 wt-%, based on the total weight of the beadlets, of at least one hygroscopic plant extract (preferably cruciferous plant extract) and

(ii) at least one starch and/or at least one starch derivative.

The invention also relates to beadlets (B2) comprising

(i) up to 85 wt-%, based on the total weight of the beadlets, of at least one hygroscopic plant extract (preferably cruciferous plant extract), and

(ii) at least one starch and/or at least one starch derivative.

Preferred beadlets (B1′) according to present invention comprise

(i) at least 30 wt-%, based on the total weight of the beadlets, of at least one hygroscopic plant extract (preferably cruciferous plant extract) and

(ii) up to 70 wt-%, based on the total weight of the beadlets, of at least one starch and/or at least one starch derivative.

The beadlets (B2′) comprise

(i) up to 85 wt-%, based on the total weight of the beadlets, of at least one hygroscopic plant extract (preferably cruciferous plant extract), and

(ii) at least 15 wt-%, based on the total weight of the beadlets, of at least one starch and/or at least one starch derivative.

Preferred starch covered beadlets according to present invention comprise at least 5 wt-%, based on the total weight of the beadlets, of the power coating layer.

Therefore (B1), (B1′), (B2) and (B2′) preferably comprise 5 wt-%, based on the total weight of the beadlets, of powder coating layer.

More preferred beadlets according to the present invention (B3) comprise

(i) 30 wt-%-80 wt-%, preferably 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, and

(ii) 15 wt-%-65 wt-%, preferably 25 wt-%-50 wt-%, based on the total weight of the beadlets, of at least one starch and/or starch derivative chosen from the groups consisting of corn starch, sorghum starch, wheat starch, rice starch, tapioca starch, arrowroot starch, sago starch, potato starch, quinoa starch and amaranth starch, pregelatinised starches, acidic modified starches, oxidized starches, cross-linked starches, starch esters, starch ethers, dextrins and cationic starches (preferred are starches with a high amount of amylopectin, OSA starches, (malto)dextrins and pregelatinised starches), and

(iii) 5 wt-%-50 wt-%, preferably 5 wt-%-20 wt-%, based on the total weight of the beadlets, of powder coating chosen from the group consisting of starches (preferably corn starch), silicate and phosphate compounds.

Especially preferred beadlets according to the present invention (B3′) comprise

(i) 30 wt-%-80 wt-%, based on the total weight of the beadlets, of at least one broccoli extract, and

(ii) 15 wt-%-65 wt-%, based on the total weight of the beadlets, of at least one starch and/or starch derivative chosen from the groups consisting of corn starch, sorghum starch, wheat starch, rice starch, tapioca starch, arrowroot starch, sago starch, potato starch, quinoa starch and amaranth starch, pregelatinised starches, acidic modified starches, oxidized starches, cross-linked starches, starch esters, starch ethers, dextrins and cationic starches (preferred are starches with a high amount of amylopectin, OSA starches, (malto)dextrins and pregelatinised starches), and

(iii) 5 wt-%-50 wt-%, based on the total weight of the beadlets, of powder coating chosen from the group consisting of starches (preferably corn starch), silicate and phosphate compounds.

Most preferred beadlets according to the present invention (B3″) comprise

(i) 40 wt-%-70 wt-%, based on the total weight of the beadlets, of at least one broccoli extract, and

(ii) 25 wt-%-50 wt-%, based on the total weight of the beadlets, of at least one starch and/or starch derivative chosen from the groups consisting of corn starch, sorghum starch, wheat starch, rice starch, tapioca starch, arrowroot starch, sago starch, potato starch, quinoa starch and amaranth starch, pregelatinised starches, acidic modified starches, oxidized starches, cross-linked starches, starch esters, starch ethers, dextrins and cationic starches (preferred are starches with a high amount of amylopectin, OSA starches, (malto)dextrins and pregelatinised starches), and

(iii) 5 wt-%-20 wt-%, based on the total weight of the beadlets, of powder coating chosen from the group consisting of starches (preferably corn starch), silicate and phosphate compounds.

Beadlets comprising a high amount (at least 30 wt-%) of hygroscopic plant extracts in a matrix comprising at least one protein are not known from the prior art.

A further embodiment of the present invention relates to beadlets (B4) comprising

(i) at least 30 wt-%, based on the total weight of the beadlets, of at least one hygroscopic plant extract (preferably cruciferous plant extract) and

(ii) at least one protein.

The invention also relates to beadlets (B5) comprising

(i) up to 85 wt-%, based on the total weight of the beadlets, of at least one hygroscopic plant extract (preferably cruciferous plant extract), and

(ii) at least one protein.

Preferred beadlets (B4′) according to present invention comprise

(i) at least 30 wt-%, based on the total weight of the beadlets, of at least one hygroscopic plant extract (preferably cruciferous plant extract) and

(ii) up to 70 wt-%, based on the total weight of the beadlets, of at least protein.

The beadlets (B5′) comprise

(i) up to 85 wt-%, based on the total weight of the beadlets, of at least one hygroscopic plant extract (preferably cruciferous plant extract), and

(ii) at least 15 wt-%, based on the total weight of the beadlets, of at least one protein.

The beadlets (B5″) comprise

(i) up to 85 wt-%, based on the total weight of the beadlets, of at least one hygroscopic plant extract (preferably cruciferous plant extract), and

(ii) at least 15 wt-%, based on the total weight of the beadlets, of gelatine and sucrose.

Preferred starch covered beadlets according to present invention comprise at least 5 wt-%, based on the total weight of the beadlets, of the power coating layer.

Therefore (B4), (B4′), (B5), (B5′) and (B5″) preferably comprise 5 wt-%, based on the total weight of the beadlets, of powder coating layer.

More preferred beadlets according to the present invention (B6) comprise

(i) 30 wt-%-80 wt-%, preferably 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower preferably broccoli, and

(ii) 15 wt-%-65 wt-%, preferably 25 wt-%-50 wt-%, based on the total weight of the beadlets, of at least one protein from a plant source (such as peas, soya, castor beans, lupins, cotton, potatoes, sweet potatoes, manioc, rapeseed, sunflowers, sesame, linseed, safflower, lentils, nuts, wheat, rice, maize, barley, rye, oats and sorghum) or an animal source (such as blood, bones, skin and milk), and

(iii) 5 wt-%-50 wt-%, preferably 5 wt-%-00 wt-%, based on the total weight of the beadlet, of powder coating chosen from the group consisting of starches (preferably corn starch), silicate and phosphate compounds.

In more preferred process according to the present invention the proteins are chosen from the group consisting of gelatines (especially fish gelatines or poultry gelatines), hydrolysed gelatines and milk proteins (whey protein, casein).

Especially preferred beadlets according to the present invention (B6′) comprise

(i) 30 wt-%-80 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, preferably broccoli, and

(ii) 15 wt-%-65 wt-%, based on the total weight of the beadlets, of at least one protein chosen from the group consisting of gelatines (especially fish gelatines or poultry gelatines), hydrolysed gelatines and milk proteins (whey protein, casein), and

(iii) 5 wt-%-50 wt-%, based on the total weight of the beadlets, of powder coating chosen from the group consisting of starches (preferably corn starch), silicate and phosphate compounds.

Most preferred beadlets according to the present invention (B6″) comprise

(i) 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, preferably broccoli, and

(ii) 25 wt-%-50 wt-%, based on the total weight of the beadlets, of at least one protein chosen from the group consisting of gelatines (especially fish gelatines or poultry gelatines), hydrolysed gelatines and milk proteins (whey protein, casein), and

(iii) 5 wt-%-20 wt-%, based on the total weight of the beadlets, of powder coating chosen from the group consisting of starches (preferably corn starch), silicate and phosphate compounds.

Beadlets comprising a high amount (at least 30 wt-%) of hygroscopic plant extracts in a matrix comprising gum compounds(s) are not known from the prior art.

Therefore, a further embodiment of the present invention relates to beadlets (B7) comprising

(i) at least 30 wt-%, based on the total weight of the beadlets, of at least one hygroscopic plant extract (preferably cruciferous plant extract) and

(ii) at least one gum compound.

The invention also relates to beadlets (B8) comprising

(i) up to 85 wt-%, based on the total weight of the beadlets, of at least one hygroscopic plant extract (preferably cruciferous plant extract), and

(ii) at least one gum compound.

Preferred beadlets (B7′) according to present invention comprise

(i) at least 30 wt-%, based on the total weight of the beadlets, of at least one hygroscopic plant extract (preferably cruciferous plant extract) and

(ii) up to 70 wt-%, based on the total weight of the beadlets, of at least one gum compound.

The beadlets (B8′) comprise

(i) up to 85 wt-%, based on the total weight of the beadlets, of at least one hygroscopic plant extract (preferably cruciferous plant extract), and

(ii) at least 15 wt-%, based on the total weight of the beadlets, of at least one gum compound.

The beadlets (B8″) comprise

(i) up to 85 wt-%, based on the total weight of the beadlets, of at least one hygroscopic plant extract (preferably cruciferous plant extract), and

(ii) at least 15 wt-%, based on the total weight of the beadlets, of gum arabic and maltodextrin.

Preferred starch covered beadlets according to present invention comprise at least 5 wt-%, based on the total weight of the beadlets, of the power coating layer.

Therefore (B7), (B7′), (B8), (B8′) and (B8″) preferably comprise 5 wt-%, based on the total weight of the beadlets, of powder coating layer.

More preferred beadlets according to the present invention (B9) comprise

(i) 30 wt-%-80 wt-%, preferably 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, and

(ii) 15 wt-%-65 wt-%, preferably 25 wt-%-50 wt-%,based on the total weight of the beadlets, of at least one gum compound chosen from the groups consisting of agar, alginate, arabinoxylan, carrageenan, chitosan, gellan, curdlan, β-glucan, guar gum, gum arabic, locust bean gum, pectin, xanthan gum, and a combination of maltodextrin and gum arabic, and

(iii) 5 wt-%-50 wt-%, preferably 5 wt-%-20 wt-%, based on the total weight of the beadlets, of powder coating chosen from the group consisting of starches (preferably corn starch), silicate and phosphate compounds.

Most preferred beadlets according to the present invention (B9′) comprise

(i) 30 wt-%-80 wt-%, preferably 40 wt-%-70 wt-%, based on the total weight of the beadlets, of at least one broccoli extract, and

(ii) 15 wt-%-65 wt-%, preferably 25 wt-%-50 wt-%, based on the total weight of the beadlets, of at least one gum compound chosen from the groups consisting of agar, alginate, arabinoxylan, carrageenan, chitosan, gellan, curdlan, β-glucan, guar gum, gum arabic, locust bean gum, pectin, xanthan gum, and a combination of maltodextrin and gum arabic, and

(iii) 5 wt-%-50 wt-%, preferably 5 wt-%-20 wt-%, based on the total weight of the beadlets, of powder coating chosen from the group consisting of starches (preferably corn starch), silicate and phosphate compounds.

Further most preferred beadlets according to the present invention (B9″) comprise

(i) 30 wt-%-80 wt-%, preferably 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, preferably broccoli, and

(ii) 15 wt-%-65 wt-%, preferably 25 wt-%-50 wt-%, based on the total weight of the beadlets, of gum arabic and maltodextrin, and

(iii) 5 wt-%-50 wt-%, preferably 5 wt-%-20 wt-%, based on the total weight of the beadlets, of powder coating chosen from the group consisting of starches (preferably corn starch), silicate and phosphate compounds.

Beadlets comprising a high amount (at least 30 wt-%) of hygroscopic plant extracts in a matrix comprising at least one synthetic and/or semi-synthetic polymer are not known from the prior art.

Therefore, a further embodiment of the present invention relates to beadlets (B10) comprising

(i) at least 30 wt-%, based on the total weight of the beadlets, of at least one hygroscopic plant extract (preferably cruciferous plant extract) and

(ii) at least one synthetic and/or semi-synthetic polymer.

The invention also relates to beadlets (B11) comprising

(i) up to 85 wt-%, based on the total weight of the beadlets, of at least one hygroscopic plant extract (preferably cruciferous plant extract), and

(ii) at least one synthetic and/or semi-synthetic polymer.

Preferred beadlets (B10′) according to present invention comprise

(i) at least 30 wt-%, based on the total weight of the beadlets, of at least one hygroscopic plant extract (preferably cruciferous plant extract) and

(ii) up to 70 wt-%, based on the total weight of the beadlets, of at least one synthetic and/or semi-synthetic polymer.

The beadlets (B11′) comprise

(i) up to 85 wt-%, based on the total weight of the beadlets, of at least one hygroscopic plant extract (preferably cruciferous plant extract), and

(ii) at least 15 wt-%, based on the total weight of the beadlets, of at least one synthetic and/or semi-synthetic polymer.

Preferred starch covered beadlets according to present invention comprise at least 5 wt-%, based on the total weight of the beadlets, of the power coating layer. Therefore (B10), (B10′), (B11) and (B11′) preferably comprise 5 wt-%, based on the total weight of the beadlets, of powder coating layer.

More preferred beadlets according to the present invention (B12) comprise

(i) 30 wt-%-80 wt-%, preferably 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, and

(ii) 15 wt-%-65 wt-%, preferably 25 wt-%-50 wt-%,based on the total weight of the beadlets, of at least one synthetic and/or semi-synthetic polymer chosen from the group consisting of polyethylene glycol, carboxymethyl cellulose (CMC), carboxypropyl-methyl cellulose (HPMC), polyvinyl pyrrolidone and lignosulfonates, and

(iii) 5 wt-%-50 wt-%, preferably 5 wt-%-20 wt-%, based on the total weight of the beadlets, of powder coating chosen from the group consisting of starches (preferably corn starch), silicate and phosphate compounds.

Most preferred beadlets according to the present invention (B12′) comprise

(i) 30 wt-%-80 wt-%, preferably 40 wt-%-70 wt-%, based on the total weight of the beadlets, of at least one broccoli extract, and

(ii) 15 wt-%-65 wt-%, preferably 25 wt-%-50 wt-%, based on the total weight of the beadlets, of at least one synthetic and/or semi-synthetic polymer chosen from the group consisting of polyethylene glycol, carboxymethyl cellulose (CMC), carboxypropyl-methyl cellulose (HPMC), polyvinyl pyrrolidone and lignosulfonates, and

(iii) 5 wt-%-50 wt-%, preferably 5 wt-%-20 wt-%, based on the total weight of the beadlets, of powder coating chosen from the group consisting of starches (preferably corn starch), silicate and phosphate compounds.

Further more preferred beadlets are beadlets (B1), (B1′), (B2), (B2′), (B3), (B3′), (B3″), (B4), (B4′), (B5), (B5′), (B5″), (B6), (B6′), (B6″), (B7), (B7′), (B8), (B8′), (B8″), (B9), (B9′), (B9″), (B10), (B10′), (B11), (B11′), (B12) and (B12′) additionally comprising sugar (sucrose). These beadlets (B13) comprise 5-25 wt-%, preferably 10-20 wt-%, based on the total weight of the beadlets, of sucrose.

An especially preferred embodiment of the present invention are beadlets which comprise a mixture of maltodextrin and at least one further starch and/or starch derivative in the matrix. Therefore a further embodiment (B14) of the present invention relates to beadlets (B1), (B1′), (B2), (B2′), (B3), (B3′) and (B3″), in which the starch component (ii) comprises maltodextrin and at least one further starch and/or starch derivative.

A further embodiment according to the present invention relates to the use of the beadlets (B1), (B1′), (B2), (B2′), (B3), (B3′), (B3″), (B4), (B4′), (B5), (B5′), (B5″), (B6), (B6′), (B6″), (B7), (B7′), (B8), (B8′), (B8″), (B9), (B9′), (B9″), (B10), (B10′), (B11), (B11′), (B12), (B12′), (B13) and (B14) in food products (for humans and/or animals), dietary supplements as well in the production of food products and dietary supplements.

Depending what kind of cruciferous plant extracts and/or matrix materials are used, the food product is suitable for humans or animals. In some cases a food product could be consumed by humans and animals.

Food products (for humans and/or animals) in the context of the present comprise liquid and solid food products as well as paste-like and or gel like. The food products comprise food for humans as well as for animals (especially ruminants, poultry and swine).

A dietary supplement, also known as food supplement or nutritional supplement, is a preparation intended to supply nutrients, such as vitamins, minerals, fatty acids or amino acids that are missing or are not consumed in sufficient quantity in a person's diet.

The food product can be in a ready-to-consume form that means a form, which is suitable to eat without further proceedings. But it is also possible that food product is a form, which needs further proceedings, like heating, dissolving, diluting, etc.

Suitable human food products can be drinks, soups, bars (cereal, chocolate), dairy products, etc.

Suitable animal food products (feed products) can be in any commonly used form.

Therefore a further embodiment of the present invention relates to human and animal food products and to human and animal dietary supplements comprising beadlets as described above.

Premixes are a convenient usage form for the food producers but are a critical medium for various ingredients due to pH, ionic strength and water activity values, which can negatively affect viability of various ingredients. But the beadlets according to the present invention eliminate (or at least strongly minimize) such problems.

The beadlets according to the present invention can also be used in premixes for food products (for humans and/or animals) and for dietary supplements (for humans and/or animals

A further embodiment of the present invention is a premix for food products (for humans and/or animals) and for dietary supplements (for humans and/or animals) comprising beadlets according to the present invention.

Functional ingredients like vitamins and trace elements are often added to food or feed products as well as to premixes.

The following examples serve to illustrate the invention. The percentages are expressed in weight percentages and the temperatures are degrees Celsius, if not otherwise defined.

### EXAMPLE 1

### Formulation of Broccoli Extract in a Matrix Comprising Amylopectin

6 g of amylopectin were added to 20 ml of water. The mixture was heated and stirred until dissolution occurred. To this solution, 30 g broccoli extract, dissolved in 40 g water were added under stirring. About 82 g of the solution was sprayed in a spraying pan in a bed of fluidized starch at about 5° C. by means of a rotating spraying nozzle. The so-obtained beadlets were separated from excess starch by sieving and dried. There were obtained ca. 83 g of dry powder

### EXAMPLE 2

### Formulation of Broccoli Extract in a Matrix Comprising in a Matrix Comprising Fish Gelatine and Sugar

51 g hygroscopic broccoli extract, 6 g fish gelatine and 3 g sugar were added to 35 g water. The mixture was stirred until dissolution occurred. About 80 g of the solution was sprayed in a spraying pan in a bed of fluidized starch at about 5° C. by means of a rotating spraying nozzle. The so-obtained beadlets were separated from excess starch by sieving and dried. There were obtained ca. 90 g of dry, non-hygroscopic powder.

### EXAMPLE 3

### Formulation of Broccoli Extract in a Matrix Comprising Gum

54 g hygroscopic broccoli extract and 6 g gum arabic were added to 35 g water. The mixture was stirred until dissolution occurred. About 80 g of the solution was sprayed in a spraying pan in a bed of fluidized starch at about 5° C. by means of a rotating spraying nozzle. The so-obtained beadlets were separated from excess starch by sieving and dried. There were obtained ca. 90 g of dry, non-hygroscopic powder.

### EXAMPLE 4

### Formulation of Broccoli Extract in a Matrix Comprising PEG 1000

54 g hygroscopic broccoli extract and 6 g polyethylene glycol PEG1000 were added to 35 g water. The mixture was stirred until dissolution occurred. About 80 g of the solution was sprayed in a spraying pan in a bed of fluidized starch at about 5° C. by means of a rotating spraying nozzle. The so-obtained beadlets were separated from excess starch by sieving and dried. There were obtained ca. 90 g of dry, non-hygroscopic powder.

1. A process for preparing beadlets, which comprise at least one hygroscopic plant extract, comprising:
(a) forming an aqueous solution of
(i) at least one hygroscopic plant extract and
(ii) at least one starch and/or starch derivate,
(b) converting the solution into a dry powder by spray drying into a collecting powder.

2. Process according to claim 1, wherein the hygroscopic plant extract is a cruciferous plant extract.

3. Process according to claim 2 wherein the cruciferous plant extract is chosen from the group consisting of rocket, broccoli, cabbage, watercress, radish cabbage, bok choy, collards, brussels sprouts, kohlrabi, kale, mustard greens, turnip greens and cauliflower.

4. Process according to claim 2, wherein the cruciferous plant extract is a broccoli extract.

5. Process according to claim 1, wherein the starch and/or starch derivates are chosen from the group consisting of corn starch, sorghum starch, wheat starch, rice starch, tapioca starch, arrowroot starch, sago starch, potato starch, quinoa starch and amaranth starch, OSA starches, pregelatinised starches, acidic modified starches, oxidized starches, cross-linked starches, starch esters, starch ethers, (malto)dextrins and cationic starches.

6. Process according to claim 5 wherein the starch and/or starch derivates are chosen from the group consisting of amylopectin, OSA starches, (malto)dextrin and pregelatinised starches.

7. Process according to claim 1, wherein the starch and/or starch derivates are (malto)dextrins and at least one further starch and/or at least one further starch derivative as defined in any of the preceding claims.

8. Process according to claim 1, wherein the beadlets are covered by a powder coating.

9. Process according to claim 1, wherein the beadlets comprise at least 30 wt-%, based on the total weight of the beadlets, of at least one hygroscopic plant extract.

10. A process according to claim 1, wherein the beadlets comprise up to 85 wt-%, based on the total weight of the beadlets, of at least one hygroscopic plant extract.

11. A process according to claim 1, wherein the beadlets comprise up to 80 wt-%, based on the total weight of the beadlets, of at least one hygroscopic plant extract.

12. A process according to claim 1, wherein the beadlets comprise at least 5 wt-%, preferably at least 20 wt-%, based on the total weight of the beadlets, of at least one gum compound and of the powder coating layer.

13. A process according to claim 1, wherein the beadlets comprise at least 5 wt-%, based on the total weight of the beadlets, of powder coating layer.

14. Beadlets comprising
(i) at least 30 wt-%, based on the total weight of the beadlets, of at least one hygroscopic plant extract and
(ii) at least one starch and/or starch derivative.

15. Beadlets according to claim 14 comprising up to 85 wt-%, based on the total weight of the beadlets, of at least hygroscopic plant extract.

16. Beadlets according to claim 14, comprising
(i) at least 30 wt-%, based on the total weight of the beadlets, of at least one hygroscopic plant extract and
(ii) up to 70 wt-%, based on the total weight of the beadlets, of at least one starch and/or starch derivative.

17. Beadlets according to claim 14, wherein the hygroscopic plant extract is a cruciferous plant extract.

18. Beadlets according to claim 14, comprising
(i) 30 wt-%-80 wt-%, preferably 40 wt-%-70 wt-%, based on the total weight of the beadlets, of at least one cruciferous plant extract chosen from the group consisting of rocket, broccoli, cabbage, watercress, radish cabbage, bok choy, collards, brussels sprouts, kohlrabi, kale, mustard greens, turnip greens and cauliflower, and
(ii) 15 wt-%-65 wt-%, preferably 25 wt-%-50 wt-%, based on the total weight of the beadlets, of at least starch and/or starch derivates are chosen from the group consisting of corn starch, sorghum starch, wheat starch, rice starch, tapioca starch, arrowroot starch, sago starch, potato starch, quinoa starch and amaranth starch, OSA starches, pregelatinised starches, acidic modified starches, oxidized starches, cross-linked starches, starch esters, starch ethers, (malto)dextrins and cationic starches., and
(iii) 5 wt-%-50 wt-%, preferably 5 wt-%-20 wt-%, based on the total weight of the beadlets, of powder coating chosen from the group consisting of starches (preferably corn starch), silicate and phosphate compounds.

19. Beadlets according to claim 18, wherein the cruciferous plant extract is a broccoli extract.

20. Beadlets according to claim 14, comprising at least one starch and/or starch derivative chosen from the group consisting of amylopectin, OSA starches, meltodextrin and pregelatinised starches.

21. Beadlets according to claim 14, wherein the starch component (ii) comprising maltodextrin and at least one further starch and/or starch derivative.

22. Use of the beadlets according to claim 14, in food products (for humans and/or animals) and dietary supplements (for humans and/or animals).

23. Use of the beadlets according to claim 14, in premixes for food products (for humans and/or animals) and for dietary supplements (for humans and/or animals).

24. Food products (for humans and/or animals) and dietary supplements (for humans and/or animals) comprising beadlets according to claim 14.

25. Premix for food products (for humans and/or animals) and for dietary supplements (for humans and/or animals) comprising beadlets according to claim 14.
